(19) United States
(12) Patent Application Publication
(10) Pub. No.: US 2024/0018329 A1
(43) Pub. Date: Jan. 18, 2024

(54) METHOD AND SYSTEM FOR RECYCLING POLYVINYLIDENE CHLORIDE CONTAINING COMPOSITE MATERIAL

(71) Applicant: Cryovac, LLC, Charlotte, NC (US)

(72) Inventors: Slawomir Opuszko, McAdenville, NC (US); Cynthia Louise Ebner, Charlotte, NC (US); Drew V. Speer, Charlotte, NC (US)

(21) Appl. No.: 18/037,183

(22) PCT Filed: Nov. 15, 2021
(86) PCT No.: PCT/US2021/059357

§ 371 Date: May 16, 2023

Related U.S. Application Data
(60) Provisional application No. 63/114,035, filed on Nov. 16, 2020.

(51) Int. Cl. C08J 11/08; C08L 27/08; C08K 5/151; C08K 5/521

(52) U.S. Cl. CPC C08J 11/08; C08L 27/08; C08K 5/151; C08K 5/521; C08J 2327/08

(57) ABSTRACT

A method of recycling a composite material of polyolefin and polyvinylidene chloride. The composite material is subjected to a polar aprotic solvent to dissolve the polyvinylidene chloride from the composite material into the solution of the polar aprotic solvent. The undissolved composite material from the solution can be collected and rinsed. The collected undissolved composite material being substantially free from polyvinylidene chloride. The polyvinylidene chloride can be precipitated out of the solution. The precipitated polyvinylidene chloride being substantially pure polyvinylidene chloride.

### CROSS-REFERENCE TO RELATED APPLICATIONS

This application claims priority to U.S. Provisional Patent Application Ser. No. 63/114,035, filed Nov. 16, 2020 and entitled “Method and System for Recycling Polyvinylidene Chloride Containing Composite Material,” the entirety of which is incorporated herein by reference.

### BACKGROUND

The subject matter disclosed herein relates to a method for recycling polyvinylidene chloride from a composite material. More particularly a method for recycling polyvinylidene chloride from a composite material containing polyvinylidene chloride and at least one polyolefin.

Plastics recycling is a solution to reduce the demand for virgin materials. Recovering and reusing plastics diverts potential waste from landfills and reduces the demand for virgin plastics.

Many plastics are made from a blend of polymers. Multilayer packaging materials often includes blends of polymers or distinct polymers in different layers. These different polymers are used in order to achieve different performance attributes. For example, many food products require high oxygen and/or vapor barrier protection to ensure longer shelf-life and flavor enhancement. Polyvinylidene chloride is often used in multilayer structures due to its excellent barrier properties. However, plastics containing both polyolefin and polyvinylidene chloride are difficult to recycle. Polyvinylidene chloride containing films cannot be mechanically recycled due to the low thermal degradation temperature of this material. Even small amounts of polyvinylidene chloride impurities in the polyolefin leads to high levels of black carbon formation which taints other polymers. Thus, polyvinylidene chloride containing films are often sent to a landfill.

To recycle plastic materials such as films containing multiple resins requires separating the resins. One useful way to separate resins is by mechanical recycling such as sink float separation which can be used to separate distinct compounds. For example, in a blend including polyolefin and polyvinylidene chloride, since polyolefins have a density less than 1.0 g/cm³, they float in water (or other liquid with a density of 1.0 g/cm³ or more), whereas polyvinylidene chloride has a density over 1.6 g/cm³ and therefore sinks in water. Thus, allowing collection of polyvinylidene chloride and polyolefins as separate streams. Further separation can be performed by changing the specific gravity of the solution by changing the mixing ratio of the solution used in the floating separation. Additional plastic recovery processes are described in S. M. Al-Salem, P. Lettieri, J. Baeyens, “Recycling and recovery routes of plastic solid waste (PSW): A review”, Waste Management, Volume 29, Issue 10, October 2009, Pages 2625-2643, ISSN 0956-053X. While mechanical separation is useful for separating plastics materials, it does have limitations when it comes to composite materials.

Composite materials, such as those that are blend of plastic materials, or those have multiple layers of distinct compositions, do not lend themselves to mechanical separation. Normal shredding and grinding processes merely change the material into smaller pieces. This does not adequately separate the resins since layers do not separate. While there may be some separation may exist (more so with grinding), both steams of a sink float separation remain contaminated with components from the other stream. Therefore, even after mechanical recycling and sink float separation the collected polyolefin streams contains amounts of polyvinylidene chloride, typically about 5 wt % or more. Even trace amounts of polyvinylidene chloride in the polyolefin stream is problematic when trying to recycle polyolefins. The polyvinylidene chloride has a low thermal degradation temperature and turns a brown or black color as the polyolefin is heated and turned into pellets. This prohibits the collected polyolefin from being reused or as being treated as virgin-like material

Likewise, the polyvinylidene chloride contains amounts of polyolefin. Even small amounts of polyolefin have a negative impact on the barrier properties of polyvinylidene chloride. This prohibits the collected polyvinylidene chloride from being reused as a barrier resin.

The discussion above is merely provided for general background information and is not intended to be used as an aid in determining the scope of the claimed subject matter.

### BRIEF DESCRIPTION

A method of recycling a composite material of polyolefin and polyvinylidene chloride. The composite material is subjected to a polar aprotic solvent to dissolve the polyvinylidene chloride from the composite material into the solution of the polar aprotic solvent. The undissolved composite material from the solution can be collected and rinsed. The collected undissolved composite material being substantially free from polyvinylidene chloride. The polyvinylidene chloride can be precipitated out of the solution. The precipitated polyvinylidene chloride being substantially pure polyvinylidene chloride.

An advantage that may be realized in the practice of some disclosed embodiments of the method is that composite materials including polyolefin and polyvinylidene chloride can be recycled into useful stream.

In one exemplary embodiment, a method of recycling a composite material is disclosed. The method comprises the steps of a) providing a composite material having polyolefin and polyvinylidene chloride; b) subjecting the composite material to a polar aprotic solvent to dissolve at least some of the composite material into a solution with the polar aprotic solvent; c) separating the undissolved composite material from the solution, the solution including dissolved polyvinylidene chloride; and d) collecting the undissolved composite material. The collected undissolved composite material comprising less than any of 1.0 wt %, 0.9 wt %, 0.8 wt %, 0.7 wt %, 0.6 wt %, 0.5 wt %, 0.4 wt %, 0.3 wt %, 0.2 wt % or 0.1 wt % of polyvinylidene chloride.

In another exemplary embodiment, a method of recycling a composite material is disclosed. The method comprises the steps of a) providing a composite material having polyolefin and polyvinylidene chloride; b) subjecting the composite material to a polar aprotic solvent to dissolve at least some of the composite material into a solution with the polar aprotic solvent; c) separating the undissolved composite material from the solution, the solution including dissolved polyvinylidene chloride; and d) precipitating the polyvinylidene chloride out of the solution. The precipitated polyvinylidene chloride has a purity of at least 99.0 wt %, 99.1 wt %, 99.2 wt %, 99.3 wt %, 99.4 wt %, 99.5 wt %, 99.6 wt %, 99.7 wt %, 99.8 wt % or 99.9 wt %.

In another exemplary embodiment, a system for recycling a composite material is disclosed. The system including a shredder or grinder to reduce the size of a composite material, the composite material including at least polyolefin and polyvinylidene chloride. A solvent bath with a polar aprotic solvent to dissolve at least some of the composite material into a solution. A filter or screen to separate undissolved composite material from the solution, the solution including dissolved polyvinylidene chloride. A collector for precipitating and collecting the polyvinylidene chloride out of the solution. The precipitated polyvinylidene chloride having a purity of at least 99.0 wt %, 99.1 wt %, 99.2 wt %, 99.3 wt %, 99.4 wt %, 99.5 wt %, 99.6 wt %, 99.7 wt %, 99.8 wt % or 99.9 wt %.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary flowchart showing a process for recycling a composite material containing polyvinylidene chloride.

FIG. 2 is an exemplary flowchart showing a process for recycling a composite material containing polyvinylidene chloride.

FIG. 3 is an exemplary flowchart showing a process for recycling a composite material containing polyvinylidene chloride.

FIG. 4 is a resultant image of a ground barrier bag heating into a pressed at 350° F. for 2 minutes in a hydraulic press.

FIG. 5 is a resultant image of a ground barrier after being subjected to cyclohexanone at 50° C. for 2 hours, the resulting solid pressed at 350° F. for 2 minutes in a hydraulic press.

FIG. 6 is a resultant image of a ground barrier after being subjected to cyclohexanone at 80° C. for 6 hours, the resulting solid pressed at 350° F. for 2 minutes in a hydraulic press.

FIG. 7 is a resultant image of a ground barrier after being subjected to dimethyl sulfoxide at 80° C. for 2 hours, the resulting solid pressed at 350° F. for 2 minutes in a hydraulic press.

FIG. 8 is a resultant image of a ground barrier after being subjected to dimethyl sulfoxide at 80° C. for 6 hours, the resulting solid pressed at 350° F. for 2 minutes in a hydraulic press.

FIG. 9 is a resultant image of a ground barrier after being subjected to N-methyl-2-pyrrolidone 80° C. for 2 hours, the resulting solid pressed at 350° F. for 2 minutes in a hydraulic press.

FIG. 10 is a resultant image of a ground barrier after being subjected to N-methyl-2-pyrrolidone at room temperature for 3 hours, the resulting solid pressed at 350° F. for 2 minutes in a hydraulic press.

FIG. 11 is a resultant image of a ground barrier after being subjected to dihydrolevoglucosenone at 50° C. for 5 hours, the resulting solid pressed at 350° F. for 2 minutes in a hydraulic press.

FIG. 12 is a resultant image of a ground barrier after being subjected to dihydrolevoglucosenone at 90° C. for 5 hours, the resulting solid pressed at 350° F. for 2 minutes in a hydraulic press.

FIG. 13 is a resultant image of a ground barrier after being subjected to triethyl phosphate at 90° C. for 1 hour, the resulting solid pressed at 350° F. for 2 minutes in a hydraulic press.

FIG. 14 is a resultant image of a ground barrier after being subjected to tetrahydrofuran at room temperature for 1.5 hours, the resulting solid pressed at 350° F. for 2 minutes in a hydraulic press.

FIG. 15 is a FTIR spectrum of the precipitated powder from dimethyl sulfoxide solvent.

FIG. 16 is a FTIR spectrum of the precipitated powder from N-methyl-2-pyrrolidone solvent.

FIG. 17 is a FTIR spectrum of the precipitated powder from dihydrolevoglucosenone solvent.

FIG. 18 is a FTIR spectrum of the precipitated powder from triethyl phosphate solvent.

FIG. 19 is a FTIR spectrum of the precipitated powder from tetrahydrofuran solvent.

FIG. 20 is an image of cut strips of a multilayer film.

FIG. 21 is an image of the cut strips of FIG. 20 in a solution of tetrahydrofuran.

FIG. 22 is an image of the delaminated strips of FIG. 20 after removal from the solution as shown in FIG. 21.

### DETAILED DESCRIPTION

Composite materials such as multilayer films are often made of layers of distinct resins. Each layer may be a single resin compound, or a blend of resins. For example, and not limited to resins include, but are not limited to polyolefins, polyesters, polypropylene, methacrylic acid copolymers, ionomer, ethylene methacrylic acid copolymers, ethylene-vinyl acetate, methylene-vinyl acetate, ethylene vinyl alcohol, polyvinylidene chloride. As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

Multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

As used herein, the term “polyolefin” refers to olefin polymers and copolymers, especially ethylene and propylene polymers and copolymers, and to polymeric materials having at least one olefinic comonomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, modified polymers of the foregoing, and the like. Modified polyolefins include modified polymers prepared by copolymerizing or grafting the homopolymer of the olefin or copolymer thereof with an unsaturated carboxylic acid, e.g., maleic acid, fumaric acid or the like, or a derivative thereof such as the anhydride, ester metal salt or the like. It could also be obtained by incorporating into the olefin homopolymer or copolymer, an unsaturated carboxylic acid, e.g., maleic acid, fumaric acid or the like, or a derivative thereof such as the anhydride, ester metal salt or the like. In an embodiment, the heat seal layer is mainly composed of polyolefin.

Ethylene homopolymer or copolymer refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; or ethylene/(meth)acrylic acid copolymer. Ethylene/alpha-olefin copolymer herein refers to copolymers of ethylene with one or more comonomers selected from C4 to C10 alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to ethylene/alpha-olefin copolymers and which high pressure polyethylenes contain both long chain and short chain branches. Ethylene/alpha-olefin copolymers include one or more of the following: 1) high density polyethylene, for example having a density greater than 0.94 g/cm³, 2) medium density polyethylene, for example having a density of from 0.93 to 0.94 g/cm³, 3) linear medium density polyethylene, for example having a density of from 0.926 to 0.94 g g/cm³, 4) low density polyethylene, for example having a density of from 0.915 to 0.939 g/cm³, 5) linear low density polyethylene, for example having a density of from 0.915 to 0.935 g/cm³, 6) very-low or ultra-low density polyethylene, for example having density below 0.915 g/cm³, and homogeneous ethylene/alpha-olefin copolymers. Homogeneous ethylene/alpha-olefin copolymers include those having a density of less than about any of the following: 0.925, 0.922, 0.92, 0.917, 0.915, 0.912, 0.91, 0.907, 0.905, 0.903, 0.90, and 0.86 g/cm³. Unless otherwise indicated, all densities herein are measured according to ASTM D1505.

Polyvinylidene chloride refers to vinylidene chloride homopolymers or copolymers. A polyvinylidene chloride copolymer, comprises a major amount of vinylidene chloride and a minor amount of one or more comonomers. A major amount is defined as one of more than 50%.

To recycle composite materials such as films containing multiple resins requires separating the resins. While mechanical recycling techniques may be useful for separating distinct components, those techniques cannot adequately separate composite materials. As used herein, composite materials are materials that contain multiple layers bonded together through lamination, coating or coextrusion, the layers being of distinct compositions or single layers having a blend of two or more distinct classifications of compounds. For example, a multilayer film having a barrier layer where the barrier layer is polyvinylidene chloride (PVDC) and other layers of the film include polyolefin. Another example of a composite article includes a monolayer structure which is a blend of polyvinylidene chloride and polyolefin. Other composite materials include, either blended or in distinct layers, polyvinylidene chloride and polyolefin plus one or more of the following additional resins: polyamides, polyesters, polypropylene, ionomer and ethylene vinyl alcohol.

Polyamide refers to polymers having amide linkages along the molecular chain, and include synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. Polyamides include those of the type that may be formed by the polycondensation of one or more diamines with one or more diacids and/or of the type that may be formed by the polycondensation of one or more amino acids. Polyamides also include amorphous, crystalline or partially crystalline, aromatic or partially aromatic polyamides.

Polyesters includes polymers made by: 1) condensation of polyfunctional carboxylic acids with polyfunctional alcohols, 2) polycondensation of hydroxycarboxylic acid, and 3) polymerization of cyclic esters (e.g., lactone). The polyester may be selected from random polymerized polyester or block polymerized polyester. Polyesters may be thermoplastic. The polyester may be substantially amorphous, or may be partially crystalline (semi-crystalline).

In some embodiments, the composite material is reduced in size without any additional mechanical recycling techniques applied. The size reduction is done by either shredding or grinding the composite material. Commercial shredders and grinders are utilized to reduce the size of plastic materials. When shredded the average size of material is from 0.1 cm to 5 cm, 0.3 cm to 3 cm, or 0.5 cm to 2 cm in either one direction or both directions. While other sizes are contemplated, it is understood that smaller sizes may be beneficial in speeding rate of dissolving polyvinylidene chloride in later processing steps. When grinding, particle size is often reduced to less than 1.6 cm, 1.4 cm, 1.2 cm, 1.0 cm, 0.8 cm, or 0.6 cm. In some embodiments, mechanical recycling techniques are used to separate at least some of the material from the composite materials. For example, sink float separation can be used to separate a float stream from a sink stream. In a blend including polyolefin and polyvinylidene chloride, since polyolefins have a density less than 1.0 g/cm³, they float in water (or other liquid with a density of 1.0 g/cm³ or more), whereas polyvinylidene chloride has a density over 1.6 g/cm³ and therefore sinks in water. Thus, allowing collection of polyvinylidene chloride and polyolefins as separate streams. Further separation can be performed by changing the specific gravity of the solution by changing the mixing ratio of the solution used in the floating separation. As discussed above, even after sink float separation, both the sink and float streams tend to be contaminated with materials from the other stream.

To remove the polyvinylidene chloride from the composite, the composite material is subjected to a polar aprotic solvent. The polar aprotic solvent pulls the polyvinylidene chloride into the solvent while the other components of the composite material remains in solid form. The remaining solids are collected from the polar aprotic solvent. In embodiments, the collected solids are then rinsed and dried. The solids after being rinsed and dried have less than any of 1.0 wt %, 0.9 wt %, 0.8 wt %, 0.7 wt %, 0.6 wt %, 0.5 wt %, 0.4 wt %, 0.3 wt %, 0.2 wt % or 0.1 wt % of polyvinylidene chloride. In embodiments where the composite material includes only polyvinylidene chloride and polyolefin, the rinsed and dried solids have a polyolefin purity of at least 99.0 wt %, 99.1 wt %, 99.2 wt %, 99.3 wt %, 99.4 wt %, 99.5 wt %, 99.6 wt %, 99.7 wt %, 99.8 wt % or 99.9 wt %. In some embodiments, the remaining solid materials are also melted and pelletized.

In embodiments the polar aprotic solvent is at least 90%, 95%, 99% or essentially all of a material selected from the group consisting of N-methyl-2-pyrrolidone, cellulose derived dipolar aprotic solvents such as dihydrolevoglucosenone, triethyl phosphate, tetrahydrofuran and blends thereof. In embodiments, subjecting the polyolefin and polyvinylidene chloride to the polar aprotic solvent is a solvolysis reactions. The ratio of polar aprotic solvent to solid materials being at least any of the following 30:70, 40:60, 50:50, 60:40, 70:30 or 80:20 as measured in weight percent.

The process of subjecting the polyolefin and polyvinylidene chloride material to the polar aprotic solvent is conducted at lower temperatures and pressure which reduces energy requirements. In embodiments, the process is conducted at standard atmospheric pressure. In other embodiments, the process is conducted at an increased pressure such as from 200 kPa to 1000 kPa. In embodiments, the polar aprotic solvent has a temperature of less than any of 160° C., 150° C., 140° C. or 130° C., 120° C., 110° C., 100° C., 90° C., 80° C., 70° C., or 60° C. In some embodiments, the polar aprotic solvent is at room temperature. In embodiments, the pressure and temperature are adjusted such that at least 99 wt % of the polyvinylidene chloride is pulled into solution in less than 5, 4, 3, 2 or 1 hours.

In embodiments after the solid materials are removed from the solvent, the polyvinylidene chloride is precipitated out of the solvent and collected. The polyvinylidene chloride can be precipitated from solution by the use of any suitable non-solvent such as water and/or alcohols. In embodiments the precipitated polyvinylidene chloride has a purity of at least 99.0 wt %, 99.1 wt %, 99.2 wt %, 99.3 wt %, 99.4 wt %, 99.5 wt %, 99.6 wt %, 99.7 wt %, 99.8 wt % or 99.9 wt %. In embodiments, the collected polyvinylidene chloride can be stabilized and prepared for reuse in polyvinylidene chloride operations.

It is understood that additional screening or filter may be utilized to collect the solid materials and also the precipitated polyvinylidene chloride from the polar aprotic solvent. Screening and filter apparatus are known to those skilled in the art. To increase efficiency of the process, the solvent may be recirculated in a steady state operation or may be purified by any suitable techniques and reused in batch processes.

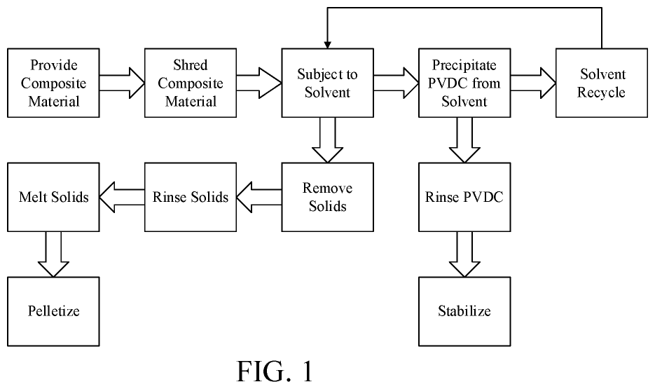

Turning now to FIG. 1 there is shown an exemplary flowchart of a system and process of recycling a composite material that contains polyvinylidene chloride and polyolefin according to embodiments. A composite material is provided and shredded into smaller particles sizes. While not shown, optional mechanical recycling techniques may be utilized. The shredded composite material comprises polyolefin and polyvinylidene chloride. In embodiments, the composite material contains at least 50 wt %, 55 wt %, 60 wt %, 65 wt %, 70 wt % or 75 wt % polyolefin. In embodiments, the composite material contains at least 5 wt %, 10 wt %, 15 wt %, 20 wt % or 25 wt % polyvinylidene chloride. In embodiments, the composite material is a multilayer film.

The composite material is subjected to a polar aprotic solvent to pull at least some of the composite material into a solution. In embodiments, the polar aprotic solvent is utilized at a low operating temperature and standard or low pressure. Lower operating temperatures allows for reduced energy costs. In embodiments, the polar aprotic solvent has a temperature of less than any of 160° C., 150° C., 140° C. or 130° C., 120° C., 110° C., 100° C., 90° C., 80° C., 70° C., or 60° C. In embodiments subjecting the composite material to a polar aprotic solvent is done at standard pressure plus or minus 50 kPa. The polyvinylidene chloride is pulled into the solution while the remaining resins of the composite material remains solid. In embodiments, the pulling of polyvinylidene chloride into the solution is via a solvolysis reaction.

The solids are removed from the solvent. In some embodiments, screening or filtering is utilized to remove the solids from the solvent. The collected solids, which are the undissolved composite material, are then rinsed which results in material that has less than any of 1.0 wt %, 0.9 wt %, 0.8 wt %, 0.7 wt %, 0.6 wt %, 0.5 wt %, 0.4 wt %, 0.3 wt %, 0.2 wt % or 0.1 wt % of polyvinylidene chloride.

In some embodiments, the rinsed collected undissolved composite material is then melted and pelletized by processes known to those skilled in the art. For example, method of palletization of polymer as described in U.S. Pat. No. 6,339,109 to Day et al. The resulting pellets being substantially pure polyolefin.

After the solids are removed from solution, the polyvinylidene chloride is precipitated out of the solution. The precipitated polyvinylidene chloride can be filtered, rinsed, dried and collected. In some embodiments, the collected polyvinylidene chloride is then stabilized by known processes and reused as a barrier material. The collected polyvinylidene chloride having a purity of at least 99.0 wt %, 99.1 wt %, 99.2 wt %, 99.3 wt %, 99.4 wt %, 99.5 wt %, 99.6 wt %, 99.7 wt %, 99.8 wt % or 99.9 wt %.

In some embodiments, the solvent is reused rendering the process more efficient with less waste. In embodiments, the process is part of a recirculating system.

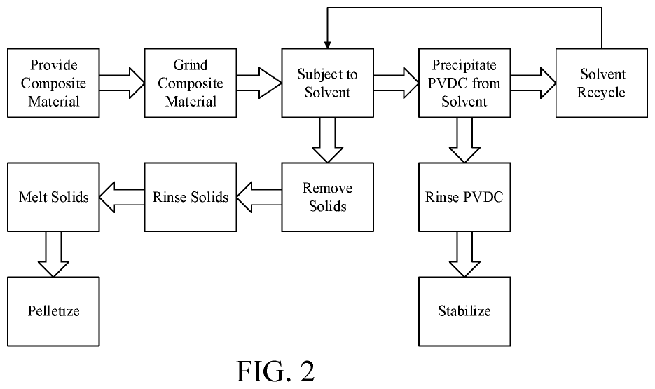

Turning now to FIG. 2 is another exemplary flowchart of a system and process of recycling a composite material that contains polyvinylidene chloride and polyolefin according to embodiments. The process is similar to the process described herein with respect to FIG. 1 except that the material is ground instead of shredded. Grinding the material generally results in smaller particle size and may partially separate some of the layers from a multilayer structure.

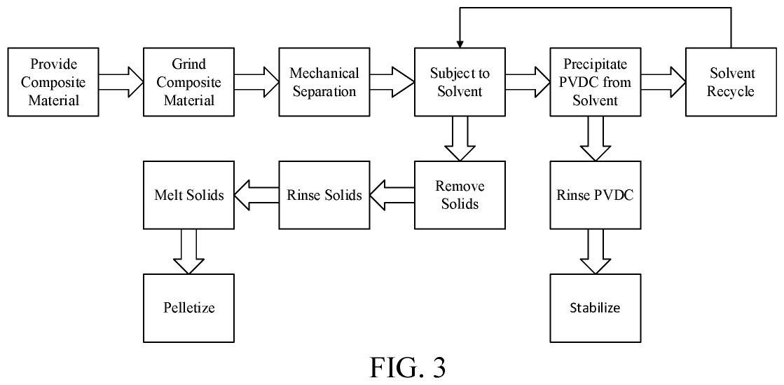

Turning now to FIG. 3 is another exemplary flowchart of a system and process of recycling a composite material that contains polyvinylidene chloride and polyolefin according to embodiments. The process is similar to the process described herein with respect to FIG. 3 with additional mechanical separation performed after grinding the composite material and before subjecting the material to the solvent. In embodiments non-compatible materials may be removed from the process prior to subjecting the materials to the solvent.

### Examples

A multilayer film B2690 Commercially available from Sealed Air containing 16 wt % polyvinylidene chloride was utilized for the following examples. 10 g of ground film was mixed with 50 mL of the listed solvents and stirred with a magnetic stirrer at the temperature and time as indicated. The mixture was then filtered to separate the undissolved materials. Those solids were washed with an additional 10-15 ml of solvent and dried in a vacuum oven overnight.

The presumed solids were analyzed by heating into a pressed film at 350° F. for 2 minutes in a hydraulic press. Pure polyolefins will remain colorless in this test, while polyvinylidene chloride will turn dark brown/black. The test samples were each examined for any brown/black discolorations, which would indicate if the polyvinylidene chloride was not completely removed.

The solvent soluble fraction, containing dissolved polyvinylidene chloride, was treated with either water, or alcohol such as methanol, ethanol or isopropanol, to precipitate the polyvinylidene chloride out of solution. The solid material was filtered and dried in a vacuum oven. The precipitated, dried powder was analyzed by FTIR to confirm purity.

### Control

The 10 g of ground film was not subjected to any solvent. The ground film after the heated press is shown is FIG. 4 as a control to demonstrate the discoloration of the polyvinylidene chloride in the material due to the thermal degradation of the polyvinylidene chloride.

### Comparative—Cyclohexanone

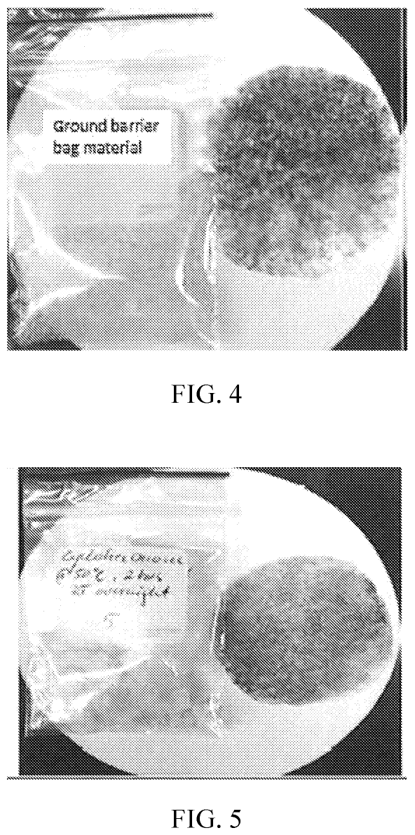

The 10 g of ground film was placed in 50 mL of cyclohexanone as described above at a temperature of 50° C. for 2 hours. The resulting pressed solid showed discoloration due to the thermal degradation of the polyvinylidene chloride as shown in FIG. 5.

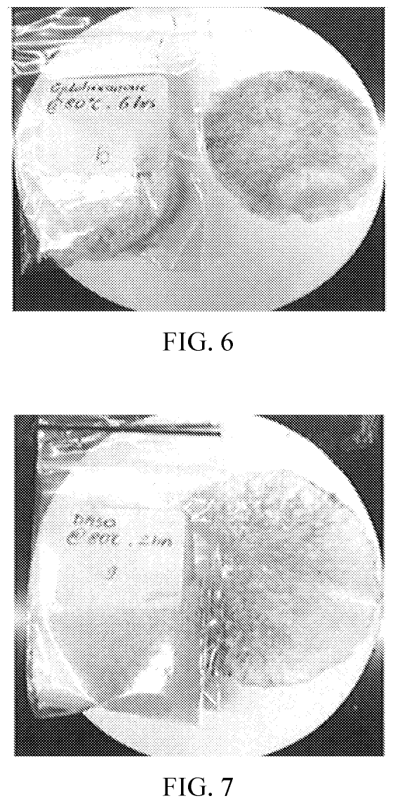

To test the additional solvent exposure, the 10 g of ground film was placed in 50 mL of cyclohexanone as described above at a temperature of 80° C. for 6 hours. The resulting pressed solid showed discoloration due to the thermal degradation of the polyvinylidene chloride as shown in FIG. 6.

### Dimethyl Sulfoxide

The 10 g of ground film was placed in 50 mL of dimethyl sulfoxide as described above at a temperature of 80° C. for 2 hours. The resulting pressed solid showed discoloration due to the thermal degradation of the polyvinylidene chloride as shown in FIG. 7.

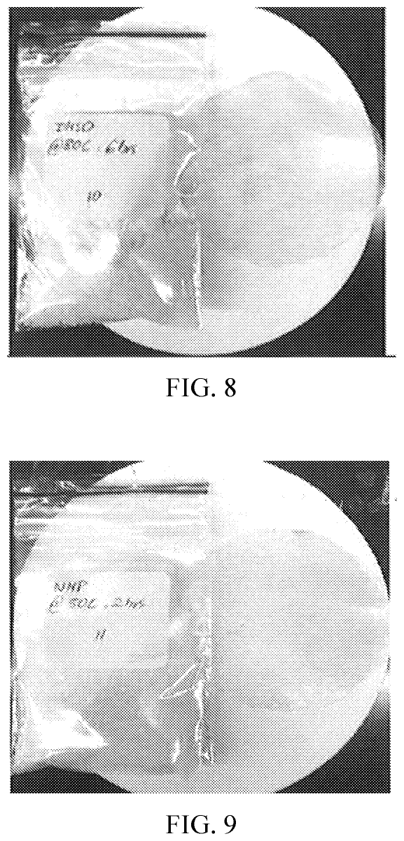

To test the additional solvent exposure, the 10 g of ground film was placed in 50 mL of dimethyl sulfoxide as described above at a temperature of 80° C. for 6 hours. The resulting pressed appeared cleaner. However, there was still some discoloration present due to the thermal degradation of the polyvinylidene chloride as shown in FIG. 8.

### N-methyl-2-pyrrolidone

The 10 g of ground film was placed in 50 mL of N-methyl-2-pyrrolidone as described above at a temperature of 80° C. for 2 hours. The resulting pressed solid showed no discoloration as shown in FIG. 9 indicating a lack of polyvinylidene chloride in the sample.

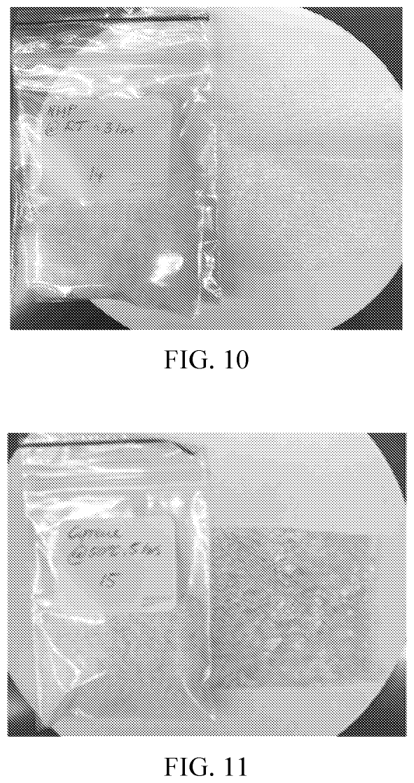

The 10 g of ground film was placed in 50 mL of N-methyl-2-pyrrolidone as described above at a temperature at room temperature for 3 hours. The resulting pressed solid showed no discoloration as shown in FIG. 10 indicating a lack of polyvinylidene chloride in the sample.

### Dihydrolevoglucosenone

The 10 g of ground film was placed in 50 mL of dihydrolevoglucosenone as described above at a temperature of 50° C. for 5 hours. The resulting pressed solid showed discoloration due to the thermal degradation of the polyvinylidene chloride as shown in FIG. 11.

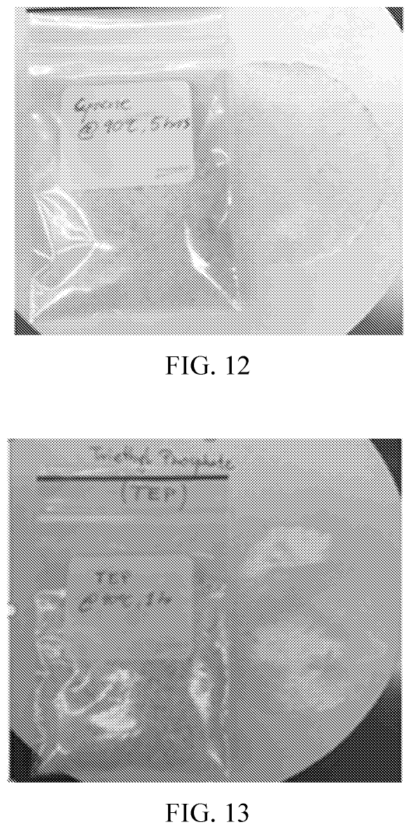

The 10 g of ground film was placed in 50 mL of dihydrolevoglucosenone as described above at a temperature of 90° C. for 5 hours. The resulting pressed solid showed no discoloration as shown in FIG. 12 indicating a lack of polyvinylidene chloride in the sample.

### Triethyl Phosphate

The 10 g of ground film was placed in 50 mL of triethyl phosphate as described above at a temperature of 90° C. for 1 hour. The resulting pressed solid showed no discoloration as shown in FIG. 13 indicating a lack of polyvinylidene chloride in the sample.

### Tetrahydrofuran

The 10 g of ground film was placed in 50 mL of tetrahydrofuran as described above at a room temperature for 1.5 hours. While polyvinylidene chloride was effectively extracted, filtering the polyvinylidene chloride from the tetrahydrofuran was difficult due to volatility of the tetrahydrofuran which caused polyvinylidene chloride solidification in the filter and quick evaporation from the suction flask. The resulting pressed solid is shown in FIG. 14.

### Reclaiming Polyvinylidene Chloride from the Solvent

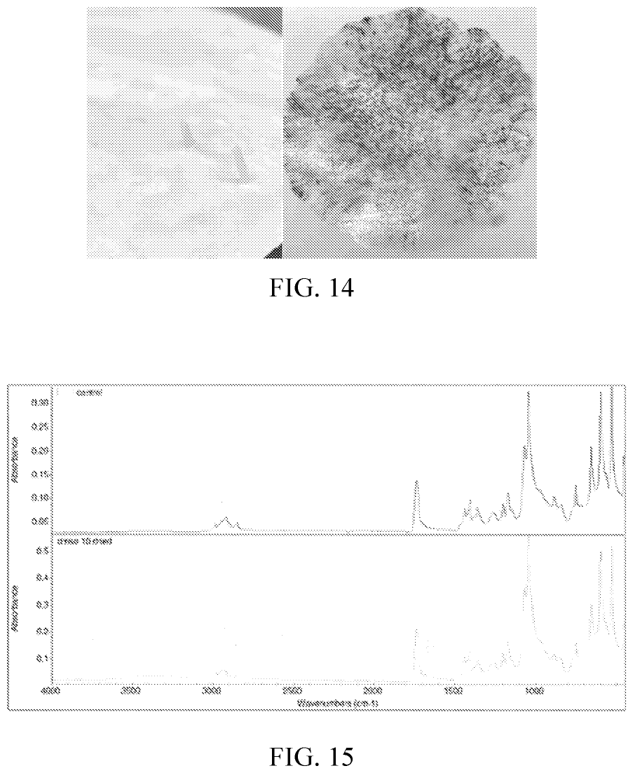

The polyvinylidene chloride was precipitated from the dimethyl sulfoxide used in the example as shown in FIG. 8. After the filtering and drying as described above the FTIR spectrum as shown in FIG. 15 shows that the sample matches polyvinylidene chloride control indicating that the precipitate is relatively pure polyvinylidene chloride.

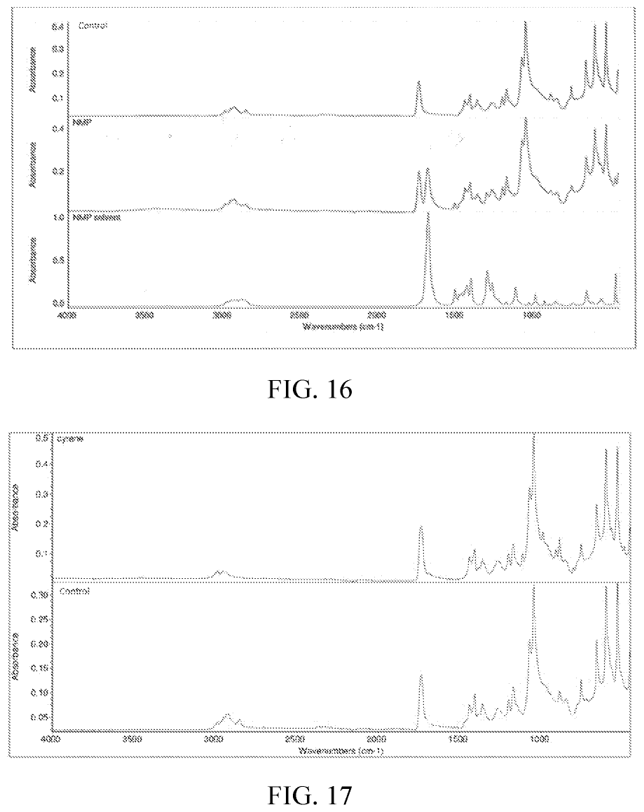

The polyvinylidene chloride was precipitated from N-methyl-2-pyrrolidone used in the example as shown in FIG. 9. After the filtering and drying as described above the FTIR spectrum as shown in FIG. 16 shows that the sample somewhat matches polyvinylidene chloride control but also shows additional peaks of the N-methyl-2-pyrrolidone solvent.

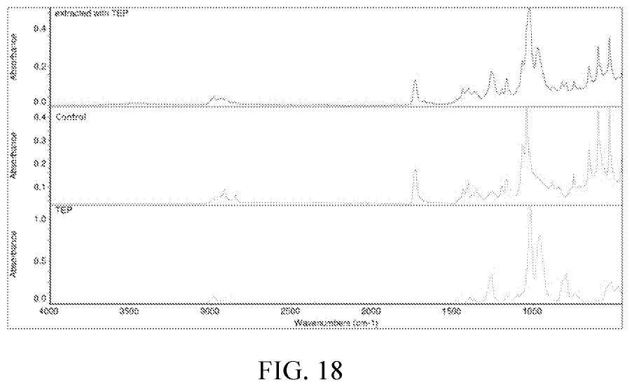

The polyvinylidene chloride was precipitated from dihydrolevoglucosenone used in the example as shown in FIG. 12. After the filtering and drying as described above the FTIR spectrum as shown in FIG. 18 shows that the sample matches polyvinylidene chloride control indicating that the precipitate is relatively pure polyvinylidene chloride.

The polyvinylidene chloride was precipitated from triethyl phosphate used in the example as shown in FIG. 13. After the filtering and drying as described above the FTIR spectrum as shown in FIG. 18 shows that the sample somewhat matches polyvinylidene chloride control but also shows additional peaks of the triethyl phosphate solvent.

### Tetrahydrofuran

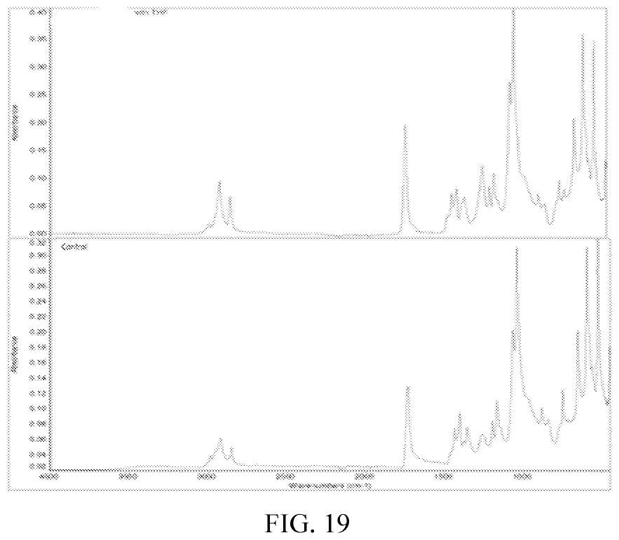

The polyvinylidene chloride was precipitated from tetrahydrofuran used in the example as shown in FIG. 14. After the filtering and drying as described above the FTIR spectrum as shown in FIG. 19 shows that the sample somewhat matches polyvinylidene chloride control but also shows additional peaks of the triethyl phosphate solvent.

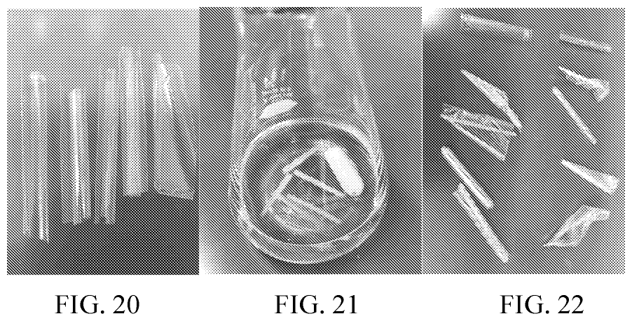

Four pieces of B2690 film, were cut with scissors into strips of approximately 1 cm×2 cm (FIG. 20) and placed in an Erlenmeyer flask containing about 30 mL of tetrahydrofuran (FIG. 21). The contents were gently stirred with a magnetic stirrer at room temperature for about 1 hour. The B2690 film has a layer polyvinylidene chloride sandwiched between other layers of the film. The tetrahydrofuran effectively dissolved the polyvinylidene chloride layer in the film causing complete delamination as depicted in FIG. 22. By achieving separation with cut films (the most difficult to separate), tetrahydrofuran solvent would also be successful in separating polyvinylidene chloride from shredded or ground material.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of recycling a composite material comprising polyolefin and polyvinylidene chloride comprising the steps of:
a. providing a composite material comprising polyolefin and polyvinylidene chloride;
b. subjecting the composite material to a polar aprotic solvent to dissolve at least some of the composite material into a solution with the polar aprotic solvent;
c. separating composite material that remains undissolved from the solution, the solution including dissolved polyvinylidene chloride; and
d. collecting the undissolved composite material;
the collected undissolved composite material comprising less than 1.0 wt % of polyvinylidene chloride.

2. The method of claim 1 wherein the polar aprotic solvent is at least 90 wt % of a material selected from selected from the group consisting of N-methyl-2-pyrrolidone, dihydrolevoglucosenone, triethyl phosphate, tetrahydrofuran and blends thereof.

3. The method of claim 2 wherein the polar aprotic solvent consists essentially of one of N-methyl-2-pyrrolidone, dihydrolevoglucosenone, triethyl phosphate or tetrahydrofuran.

4. The method of claim 1 wherein the polar aprotic solvent is at least 90 wt % a cellulose derived dipolar aprotic solvent.

5. The method of claim 1 further comprising the step of mechanically grinding or shredding the composite material prior to the step of subjecting the composite material to a polar aprotic solvent.

6. The method of claim 1 where in the composite material is a multilayer barrier film.

7. The method of claim 1 further comprising the step of precipitating the polyvinylidene chloride out of the solution.

8. The method of claim 7 wherein the precipitated polyvinylidene chloride has a purity of at least 99.0 wt %.

9. The method of claim 1 wherein the polar aprotic solvent has a temperature of less than 160° C.

10. The method of claim 1 wherein the composite material comprises at least 50 wt % polyolefin.

11. The method of claim 1 wherein the composite material comprises at least 1 wt %.

12. The method claim 1 wherein the step of subjecting the composite material to a polar aprotic solvent is for a time of less than 3 hours.

13. The method of claim 1 wherein the step of subjecting the composite material to a polar aprotic solvent is at a pressure of between 0.1 and 1.5 Atm.

14. The method of claim 1 wherein the ratio of polar aprotic solvent to solid materials being at least 30:70 as measured in weight percent.

15. The method of claim 1 wherein the polar aprotic solvent consists essentially of dihydrolevoglucosenone or triethyl phosphate.

16. The method of claim 1 wherein the polar aprotic solvent is dihydrolevoglucosenone and a has a temperature of less than 100° C.

17. The method claim 1 wherein the polar aprotic solvent is triethyl phosphate and a has a temperature of less than 100° C.

18. (canceled)

19. The method of claim 1 wherein the composite material does not include a metal.

20. The method of claim 1 further comprising the steps of:
a. rinsing the collected undissolved composite material;
b. melting the rinsed collected undissolved composite material; and
c. pelletizing the melted undissolved composite material.

21.-32. (canceled)

33. A system for recycling a composite material comprising polyolefin and polyvinylidene chloride, the system comprising:
a. a shredder or grinder to reduce the size of a composite material, the composite material comprising polyolefin and polyvinylidene chloride;
b. a solvent bath comprising a polar aprotic solvent to dissolve at least some of the composite material into a solution with the polar aprotic solvent;
c. a filter or screen to separate undissolved composite material from the solution, the solution including dissolved polyvinylidene chloride; and
d. a collector for collecting the undissolved composite material;
the undissolved composite material comprising less than 1.0 wt % of polyvinylidene chloride
